(19) United States
(12) Patent Application Publication
(10) Pub. No.: US 2008/0199362 A1
(43) Pub. Date: Aug. 21, 2008

(54) Microfluidics Package and Method of Fabricating the Same

(75) Inventors: Ser Choong Chong, Singapore (SG); Ling Xie, Singapore (SG); Hongmiao Ji, Singapore (SG); Jing Li, Singapore (SG); Yu Chen, Singapore (SG); Levent Yobas, Singapore (SG)

Correspondence Address: CONNOLLY BOVE LODGE & HUTZ LLP, 1875 EYE STREET, N.W., SUITE 1100, WASHINGTON, DC, 20036, US

(73) Assignees: AGENCY FOR SCIENCE, TECHNOLOGY AND RESEARCH, Centros (SG); NATIONAL UNIVERSITY OF SINGAPORE, (SG)

(21) Appl. No.: 11/816,396

(22) PCT Filed: Feb. 15, 2005
(86) PCT No.: PCT/SG05/00038

§ 371 Date: May 5, 2008

(51) Int. Cl. B01L 3/00

(52) U.S. Cl. 422/100

(57) ABSTRACT

A microfluidics package (1) comprising a substrate (6) having a top surface, said top surface comprises at least one fluid channel (11, 12), at least one fluidic chip (2) having a top surface, a bottom surface, at least one side surface, and at least one passage to allow a fluid to traverse from the top surface or any side surface to the bottom surface of the chip; sides are adhesive, wherein the first adhesive side of the sheet (4) is secured to the substrate (6), and the at least one fluidic chip (2) is secured by the second adhesive side of the sheet (4), said fluidic chip (2) being arranged such that the at least one passage of the fluidic chip is in fluid communication with the at least one fluid channel (11, 12) of the substrate.

The invention relates generally to the field of microfluidics. More specifically, the invention relates to microfluidic packages and methods of fabricating the same.

Over the past decade, growing interest in microfluidics has provided the impetus for its rapid development from a theoretical science to a field with important biological and biochemical applications. Microfluidic devices are being used for the quantitative study of molecular diffusion, fluid viscosity, pH, chemical binding, and enzyme reaction kinetics in biological samples. More recently, the use of microfluidic devices has extended to other applications such as capillary electrophoresis, isoelectric focusing, immunoassays, flow cytometry, drug analysis, sample injection of proteins for analysis via mass spectrometry, PCR amplification, DNA and RNA extraction, DNA analysis, cell manipulation, cell separation, cell patterning, and chemical gradient formation.

Microfluidic devices that are used for the analysis of biological fluid samples typically comprise one or more microfluidic chips that are used to analyze a sample and a biologically compatible substrate housing a series of fluid channels for delivering the sample to the microfluidic chip. One or more inlets may be present to allow the introduction of the sample and/or chemicals into the device.

One of the problems encountered in the manufacture of a microfluidic package arise from the lack of cost-effective integrative technologies for microscale and mesoscale components, which would allow microfluidic packages to be manufactured cheaply and yet still, be able to function acceptably. Relatively time-consuming methods are still required to establish a secure and robust fluidic interface and fluidic interconnections within the microfluidic package.

Recent attempts have been made to address this problem. Han et al. proposed the use of a specific liquid perfluoro polymer (CYTOP® Asahi Glass Company, Japan) to create an in-situ prepared amorphous polymer film that is dried and solidified to bond the microfluidic chip to the substrate of the microfluidic package. The CYTOP® film allows the microfluidic chip to be adhered onto the substrate and thereby maintains the alignment of the inlets and outlets of the microfluidic chip with the corresponding inlets and outlets on the substrate. (Micro Electro Mechanical Systems, 2000. MEMS 2000. 13^{th} Annual International Conference on, 23-27 Jan. 2000. Pages: 414-418). Kohl et al. suggested the use of UV curable polymers to bond and align flow sensors and microvalves to microchannels on the substrate of the microfluidic package. (Micro Electro Mechanical Systems, 2004. 17th IEEE International Conference on MEMS, 2004, Pages: 288-291.) However, the use of liquid phase polymers for bonding led to the undesirable clogging of flow channels in the package and therefore required greater precision during the assembly of the package.

Apart from the above, other methods have been suggested as well. Schabmueller et al. suggested the use of anodic bonding to establish the interface between microfluidic components and the substrate of the package. (J. Micromach, Microeng, Vol 9 (1999), pp 176-179). Jo et al. suggested the use of an oxygen plasma curable silicone elastomer (SYLGARD 184, Dow Corning) mixed with a curing agent in the weight ratio of 10:1 as a suitable material for bonding components within a microfluidic package (J. MEM Systems, Vol. 9 No. 1, 2000).

More recently, Pattekar et al. described a method of establishing the fluidic interconnections for a silicon microfluidic chip in which Teflon tubes were used to form the macro-micro interconnections. The method involved the use of thermal heat to melt the Teflon tube and the use of high temperature epoxy to secure the tube to the inlet and outlet ports (J. Micromach, Microeng. 2003, pg. 337-345). Li et al. suggested the use of plasma treatment to enable the bonding of PDMS on the microfluidic chip and further employed epoxy to enhance the bond strength.

Despite these developments there remains a need for microfluidic packages that are constructed with reliable interface connections between the interconnect flow channels and the microfluidic chip. It would be desirable to have a cost effective method of manufacturing such packages. It is also desirable to provide microfluidic packages having “plug-and-pump” connections directly from the microfluidic chip to the substrate, as well as to provide chip-to-chip microfluidic interfacing. Furthermore, it is also desirable to provide off-chip fluidic circuits within the cartridge to handle large volumes of reagents.

These problems are solved by the microfluidic package and method of assembling the microfluidic package, amongst other aspects, having the features of the respective independent claims.

Such a microfluidic package comprises a substrate having a (at least one) surface comprising at least one fluid channel, at least one fluidic chip having a top surface, a bottom surface, at least one side surface, and at least one passage to allow a fluid to traverse from the top surface or any side surface to the bottom surface of the chip; and a sheet of which both sides are adhesive. The first adhesive side of the sheet is attached to the substrate, and the at least one fluidic chip is secured by the second adhesive side of the sheet, such that the at least one passage of the fluidic chip is in fluid communication with the at least one fluid channel of the substrate.

In a further aspect, the invention provides a method of assembling the microfluidic package, said method comprising attaching a sheet comprising of two sides, both being adhesive onto the top patterned surface of the substrate or attaching said sheet to the bottom surface of the at least one fluidic chip and securing the at least one fluidic chip on top of the top surface of the substrate.

The invention also provides a method of assembling the microfluidic package of, further comprising securing a second a sheet comprising of two sides, both being adhesive, on the top surface of the at least one fluidic chip or on any exposed portion of the top surface of the substrate and securing a cover plate to the second sheet.

The invention further provides a method of fabricating the substrate of a microfluidic package. This method comprises providing a master mold comprising at least two pins for creating at least one sealed inlet passage and one sealed outlet passage, and at least one protrusion for creating at least one fluid channel, depositing a precursor of the substrate material into the master mold, and allowing the precursor to solidify, thereby forming the substrate. In this aspect, the invention also provides for a substrate that is obtainable or obtained from this method of fabricating the substrate of a microfluidic package. Such a substrate comprises: a surface, wherein this surface comprising at least one fluid channel, at least one sealed inlet passage, and at least one sealed outlet passage.

The sheet that is used in the present invention has two sides, both of which are adhesive, and may utilize a first adhesive side to attach itself to the substrate. The fluidic chip may then be attached to the second adhesive side of the sheet. The alignment and location of the fluidics chip with respect to the substrate is such that after being secured to the second adhesive side of the sheet, there exists a means of fluid communication between the at least one passage of the fluidics chip and the at least one fluid channel of the substrate. In addition, the orientation of the fluidic chip may be regarded as being substantially parallel to the plane of the surface of the substrate that features the at least one fluid channel.

The above-mentioned sheet may be continuous, meaning that it may be formed as a one-piece element. In another embodiment, the sheet may comprise a plurality of individual sheets (discontinuous), which in combination with one another may make up a larger sheet. The larger sheet may be equivalent in size and shape to the aforementioned continuous sheet, for example. Whether the sheet is continuous or discontinuous, the sheet may take the form of a regular shape such as a rectangle, square, triangle, elliptical, circle or any other known polygonal shape wherein the geometry of the said shape has at least one line of symmetry. A further embodiment includes the sheet adopting an annular (donut shaped) geometry.

Alternatively, the said sheets, whether continuous or otherwise, may take the form of an irregular shape, wherein an irregular shape is defined as a shape whose geometry has no clearly discernable line of symmetry. Therefore the sheet as such may comprise a continuous sheet or a plurality of individual sheets, wherein each sheet may be regularly or irregularly shaped. In general, regardless of the shape of the adhesive sheet, it is preferably arranged at selected portions of the substrate where it is important to ensure the presence of a secure fluidic seal. Portions of the substrate that are considered to be important for this purpose include fluid channels, fluidic ports and areas where the microfluidic chip is to be placed. The sheet may be shaped to cover these structures either entirely or partially. The sheet may also be positioned only at the edge of the substrate as described below.

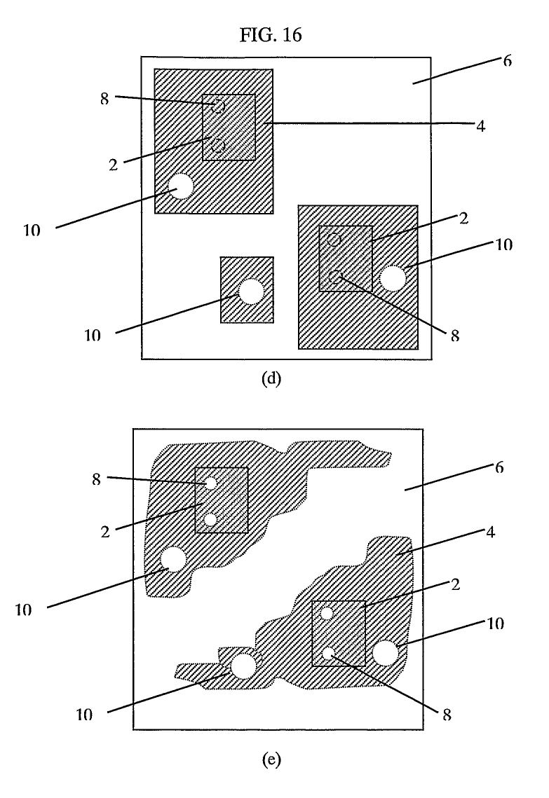

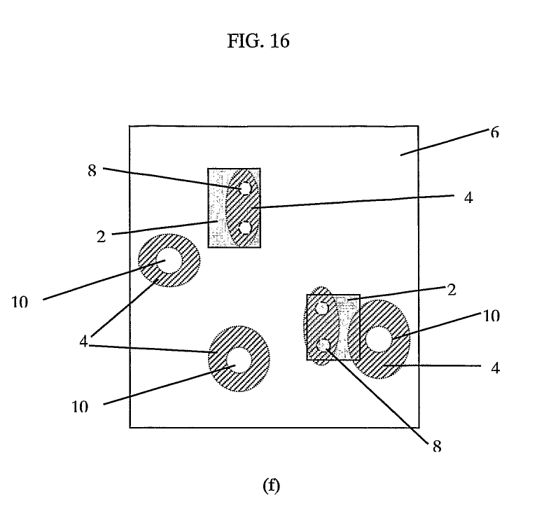

In one embodiment, the first adhesive side of the sheet is attached to the surface of the substrate wherein the at least one fluid channel is located on said surface of the substrate, such as the top surface, for example. In this embodiment, the sheet may be continuous, meaning that the sheet comprises a single piece of material. The single continuous sheet may cover the entire top surface of the substrate or it may cover only a portion of the top surface. If the top surface of the substrate is rectangular (or regularly shaped), for example, then correspondingly, the sheet will take the form of a continuous rectangular sheet spanning from one peripheral edge of the substrate to the next thereby covering the entire top surface of the substrate. Alternatively, the sheet may be triangular in shape. In such an embodiment, the sheet may not cover the entire top surface of the substrate but is restricted to selected portions of the top surface of the substrate. In other embodiments in which the continuous sheet does not cover the entire top surface of the substrate, the centre portion of the sheet is removed so that it assumes a frame-like or border-like shape which can be placed, for example, along the perimeter or peripheral edge of the top surface of the substrate (see FIG. 16, for example).

In a further embodiment the sheet may be irregularly shaped. Again, as mentioned above, the sheet may only cover selected portions of the surface of the substrate. Furthermore, in the embodiment of an irregularly shaped but continuous sheet, the sheet may also span from one peripheral edge of the substrate to the next. Accordingly, the sheet, though continuous, due to its irregular shape, may only cover selected portions of the substrate.

In a further embodiment, the sheet may also comprise a plurality of smaller sheets. Should the sheets be regularly shaped, it is possible that the sheets may be arranged in such a manner that allows the top surface of the substrate to be covered in entirety. For example, it is possible that the sheet may be of a different shape from the substrate or may not cover the surface of the substrate entirely, but takes up the form of the bottom shape of the microfluidic chips either partially or entirely. However, if the said plurality of smaller sheets is irregularly shaped, it may be possible to also cover the entire surface of the substrate although it may be preferable that the surface of the substrate is only partially covered by the said plurality of irregularly shaped sheets. This may leave irregularly shaped portions of the substrate uncovered.

Hereinafter, when reference is made to the ‘sheet’, it is to be understood that the ‘sheet’ may be, as defined above, continuous, discontinuous and comprising a plurality of individual sheets and may further be regularly or irregularly shaped.

In a further embodiment, the sheet may be secured to the top surface of the substrate such that the sheet covers the at least one fluid channel of the substrate. In this embodiment, the sheet may not cover the remaining areas of the top surface of the substrate. In another embodiment, the sheet may cover all other portions of the top surface of the substrate that do not comprise of the at least one fluid channel. In other words, the sheet may cover also the non-fluid channel portions of the top surface of the substrate.

In the above-mentioned embodiment, the sheet may be secured only to the periphery of the top surface of the substrate. In such an embodiment, the sheet may include a membrane attached in a frame-like manner to the sheet, with the sheet being situated along the peripheral edge of the membrane. In this embodiment, the centre portion of the sheet may be removed thus retaining the sheet in a frame-like manner. The centre portion of the sheet may be substituted for a suitable membrane or any other material that may serve the function of covering (and sealing) the fluid channel portions on the top surface of the substrate.

In a further embodiment, the sheet may further comprise of a membrane that is either partially or fully integrated into said sheet. The partially or wholly integrated membrane may then be aligned with the at least one fluid flow channel of the substrate such that when the sheet is secured, the at least one fluid flow channel is sealed in the manner as described above.

The membrane may be selected from any biologically compatible or inert material. Examples of such materials include polyethyleneterephthalate (PET)), polycarbonate (PC) and polyimide.

In another embodiment, the sheet may further comprise at least one through-hole. The through-hole may allow for the at least one channel of the top surface of the substrate to be in fluid communication with the at least one passage of a microfluidic chip. The term ‘microfluidic chip’ refers to a device that is well-known in the art and that comprises a network of microchannels and interconnects defined in a polymer substrate, the microchannels having typical channel dimensions in the region of 10-100 micrometers inclusive (cf. Han et al. supra or as disclosed in PCT applications WO 2005/009616 A1 and WO 2005/010377 A1). The microchannels are accessible via inlet/outlet apertures on 1 or more sides of the chip. The chip may be arranged such that the inlet/outlet apertures are facing the substrate, or it may also be arranged such that the inlet/outlet apertures face away from the substrate. In the former arrangement, fluidic communication with the microfluidic chip can be established by fluid channels or inlet/outlet ports in the substrate, while in the latter arrangement, the inlet/outlet apertures of the chip is in communication with inlet/outlet ports of the cover. Through-holes on the sheet may be achieved by any suitable means including punching, shearing, die-cutting as well as laser drilling.

With the exception of one of the above-mentioned embodiments, when the sheet covers the at least one fluid channel of the substrate, the sheet seals the at least one fluid channel of the substrate from the surroundings while maintaining the fluid communication between the at least one fluid flow channel of the substrate and the at least one fluid flow passage of the chip.

In a further embodiment the through-hole located on the sheet may be connected to the at least one fluid channel of the substrate and to the at least one passage of the fluidics chip. This allows a fluid to traverse from the top surface or any side surface of the fluidics chip to the at least one fluid channel of the top surface of the substrate.

One function of the sheet defined in the independent claim includes securing the microfluidic chip onto the substrate. For this purpose, the sheet should have an adhesive quality in order to allow secure attachment of the microfluidic chip thereon.

In one embodiment, the sheet comprises at least one supporting layer obtained from a material such as, but not limited to, elastic polymers, thermoplastic polymers and thermosetting polymers. If the supporting layer itself has inherent adhesive qualities, the supporting layer alone can be used to secure the microfluidic chip onto the substrate, without the need for any coating of additional adhesives onto the supporting layer. If the supporting layer is a non-adhesive, e.g. thermoplastic polymer such as those selected from carbon chain polymers and heterochain polymers, both surfaces of the supporting layer can be rendered adhesive by coating with adhesives. Examples of non-adhesive thermoplastic polymers from which the supporting layer may be obtained, are polyvinyl acetates and polyvinyl alcohols. In this conjunction, it is noted that it is not necessary to render the entire surface(s) of the supporting layer adhesive. Rather, it is possible for example, to only render the periphery of the surface of the side of the sheet that faces the microfluidic chip adhesive (cf., FIG. 16c, for example) and to render the entire surface of the sheet that faces the substrate adhesive. It is also possible to create “surface patches” on the side of the sheet facing the microfluidic chip which are sufficient for example, to secure the chip to the substrate.

Any biocompatible adhesive which is resistant to corrosion by reagents such as alcohols, acidic or alkaline substances, for example, and which is able to provide a sufficient amount of adhesion strength to secure the microfluidic chip, may be used as the adhesive. Suitable materials for the adhesive include the general class of pressure and/or heat-sensitive polymers. Specific examples include, but are not limited to, acrylic-based adhesives, silicone-based adhesives, phenolic-based adhesives, cyanoacrylates, amino resins, and epoxies. The adhesive is preferably present in a gel, elastomeric or resin form for convenience of use. In a presently preferred embodiment, the sheet is a medical grade double-sided adhesive tape.

The microfluidic chip may further comprise at least one fluid inlet port and at least one fluid outlet port. The at least one inlet port and the at least one outlet port may be located on the top surface, bottom surface, any of the side surfaces and in any combination of the aforementioned surfaces. In any of the above-mentioned embodiments, at least one fluidics chip is secured to the sheet. It is possible to secure the bottom surface of the fluidics chip to the sheet. The fluidics chip may also be connected, via electronic means, to a printed circuit board. The printed circuit board may contain a means, such as an algorithm, for running the microfluidic chip.

The substrate of the present device may further comprise at least one inlet port and at least one outlet port through which fluid flow occurs. The top surface of the substrate comprises of at least one fluid flow channel and one fluidic reservoir or chamber. In a further embodiment, the substrate may comprise of a plurality of fluid flow channels that are inter-connected with each other. In addition, the substrate may further comprise of at least one sample storing reservoir, which may be used to store the products or by-products that may arise as a result of the fluid flow. The reservoir may further comprise of at least one inlet port or outlet port to allow for the said products or by-products to be recovered if necessary or disposed off.

The substrate may be fabricated from any material that is resistant to corrosion induced by test reagents used in the package, as well as biologically compatible with the sample to be analyzed. In one embodiment, the substrate material is selected from a group consisting of, but not limited to, semiconducting materials and electrically insulating materials. Examples of such materials include elemental silicon, glass and polymeric silicone. As used herein, the term polymeric silicone includes all silane polymers, silicone polymers, siloxane polymers, and inorganic silicon-nitrogen based polymers.

Specific examples of polymeric silicone, which can be used in the substrate, are polydimethylsiloxane (PDMS), polydiethylsiloxane and polydipropylsiloxane. PDMS is a presently preferred material as when an injecting needle punctures it, for example, it is self-sealing due to its ability to conform to the shape of the needle, thereby ensuring minimal exposure of the internal components and contents of the microfluidic package from to the air as well as to external contaminants. In order to modify the surface quality of the substrate for improved solid-liquid interface between the substrate and a liquid sample, the surface of the substrate may also be modified with any suitable material, e.g. polyethylene glycol or polyfluoropolyether for conferring hydrophilic or hydrophobic qualities. Other examples of (biocompatible) polymerisable material from which the substrate may be made, include monomers or oligomeric building blocks (i.e. every suitable precursor molecule) of polycarbonate, polyacrylic, polyoxymethylene, polyamide, polybutylenterephthalate, polyphenylenether, mylar, polyurethane, polyvinylidene fluoride (PVDF), flourosilicone or combinations and mixtures thereof.

The microfluidic package may further comprise a cover plate secured by means of a second sheet either to the top surface of the at least one microfluidics chip or to the top surface of the substrate. The cover plate may comprise of at least one recess fabricated such that the fluidics chip may fit into said recess when the cover is placed onto the microfluidics package. The second sheet may be positioned in-between the cover plate and the top surface of the substrate. Alternatively, the second sheet may be positioned on the top surface of the fluidics chip in order to secure the cover plate. The cover plate may have 1, 2, 3, 4 or more (i.e. a plurality of) fluidic holes or inlet/outlet ports. At least one of these fluidic holes is aligned to the channel on the top surface of the substrate in order to introduce a sample or a reagent into the microfluidic package.

In one embodiment, the top cover may comprise the same material as that which is used for the substrate, for example, semiconductor materials or electrically insulating materials such as elemental silicon, glass and polymeric silicones. Specifically, the silicone may be selected from, but is not limited to polydimethylsiloxane (PDMS), polydiethylsiloxane and polydipropylsiloxane. The top cover may also be surface modified with a suitable material, e.g. polyethylene glycol or polyfluoropolyether. Likewise, the cover may be made from a (biocompatible) polymerisable such as include monomers or oligomeric building blocks (i.e. every suitable precursor molecule) of polycarbonate, polyacrylic, polyoxymethylene, polyamide, polybutylenterephthalate, polyphenylenether, mylar, polyurethane, polyvinylidene fluoride (PVDF), flourosilicone or combinations and mixtures thereof.

Another aspect of the invention relates to a method of fabricating the substrate. The method comprises first providing a master mold comprising at least two pins for creating at least one sealed inlet passage and one sealed outlet passage, and at least one protrusion for creating at least one fluid channel. Subsequently, a precursor of the substrate material is deposited into the master mold. Finally, the precursor is allowed to solidify, thereby forming the substrate.

In accordance with the above method, the master mold is designed and constructed according to the desired layout of the fluid channels and the inlet/outlet ports. Where fluid channels are to be constructed, the surface of the master mold is provided with horizontal protrusions, which correspond to the desired layout of the fluid channels in the substrate. In order for sealed fluidic ports to be made efficiently, upright pin-like protrusions are formed in the master mold, typically orientated substantially perpendicularly to the horizontal protrusions, to provide corresponding inlet/outlet port structures in the substrate. The height of the pins are designed to be lower than the height of the substrate material filling the mold so that the passageway left in the substrate by each pin-like structure is sealed off from the opposing surface of the substrate, thereby creating a sealed fluidic port in the substrate. The fabrication begins with the deposition of liquefied substrate material is into the master mold. Thereafter, the substrate material is allowed to solidify, for example, under thermal or ultraviolet curing. Once the substrate has solidified, the substrate is removed from the mold.

Any suitable conventional methods may be used for fabricating the substrate. Examples include, but are not limited to casting, molding or lithography. In one embodiment, the substrate is formed by a method selected from a group consisting of casting, molding and lithography. Exemplary methods of casting include, but are not limited to investment casting, centrifugal casting, cold casting and potting.

In another embodiment, the substrate is fabricated by molding. Exemplary methods of molding include, but are not limited to, compression molding and injection molding.

In another embodiment, the substrate is fabricated by lithography. Exemplary methods of lithography include, but are not limited to soft lithography, ultraviolet lithography and imprint lithography.

In any of the above embodiments of the method of the invention, a precursor may be selected from any suitable materials. In a presently preferred embodiment, the precursor may be selected from the group consisting of polydimethylsiloxane, polydiethylsiloxane, polycarbonate, polyethylene, polyvinylchloride, polyamides, polyethyleneterephthalate (PET)), polycarbonate (PC), polyimide and polydipropylsiloxane.

A further aspect of the invention relates to a substrate, which may be used in any microfluidics package. The substrate may be fabricated as mentioned above and may comprise of at least one surface, said surface comprising at least one fluid channel, at least one sealed inlet passage, and at least one sealed outlet passage.

It is to be noted that the substrate, in particular holes and channels in the substrate, may be formed using any suitable standard micro-machining procedure and is not limited to casting, molding or lithography, although the latter methods are preferred methods of doing so. For example, the substrate may be fabricated using injection molding, casting, machining. laser drilling, dry etching and mechanical drilling.

The master mold can be made of any suitable material for holding molten substrate material while it is being allowed to solidify in the mold. The cover plate fabrication process may be selected from a group consisting of injection molding, soft lithography, casting, chemical machining, electrical discharge machining (EDM), wire EDM, laser ablation and electron-beam machining, or by any of the above-mentioned fabrication methods as well.

The microfluidic package of the invention may be assembled by the following method comprising:

attaching a sheet, of which both sides are adhesive, to any surface of the substrate that may comprise fluid channels such as the top surface, for example, and

securing the at least one fluidic chip onto the substrate by means of the second adhesive side of the sheet thereby forming a sealed channel comprising the fluid flow passage of the fluidics chip and the fluid flow channel of the substrate.

In a further embodiment, the method of assembling the microfluidic package may further comprise:

attaching a second sheet to the top surface of the at least one microfluidic chip or to any exposed portion of the substrate that may be in contact with the cover, and

attaching the cover, to the second sheet when said cover is placed onto the microfluidics package.

The microfluidic package of the present invention is applicable in a wide range of fields. In the chemical processing industry, microfluidic packages can be used, for example, in reactors, mixers, dispensers, heat exchangers and separators for carrying out fundamental ‘unit operations’ analysis at the microfluidic scale. In the life sciences industry, microfluidic packages can be used, for example, for high throughput screening and drug discovery. As an example of the application in the field of genomics, DNA amplification can be carried out as well as cell analysis (e.g. screening, counting, sorting). In addition, diagnostic tools and biochemical monitoring of materials such as soil, water, and pesticides may also employ the microfluidic package of the invention. Other applications include miniaturized microtitre plates, dispenser components, implantable drug delivery systems, micro-combustors, fluidic micro thrusters, DNA amplification, separation, hybridization and sequencing.

The invention is further illustrated by reference to the following non-limiting examples and drawings in which;

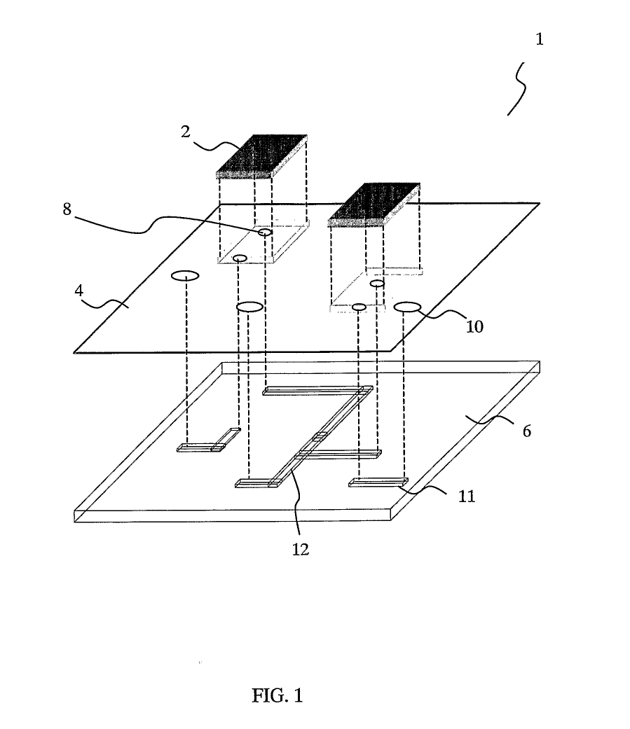

FIG. 1 illustrates an exploded isometric view of a microfluidic device.

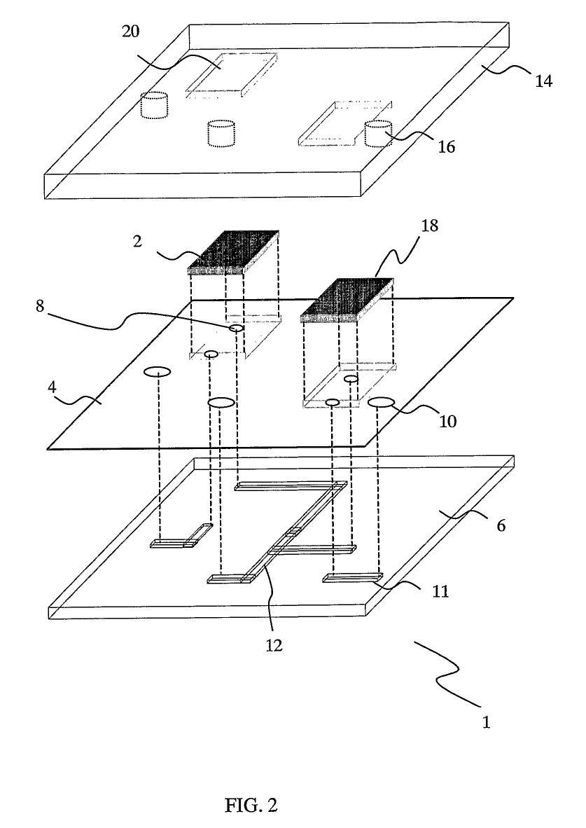

FIG. 2 shows an exploded isometric view of the microfluidic package further incorporating a cover.

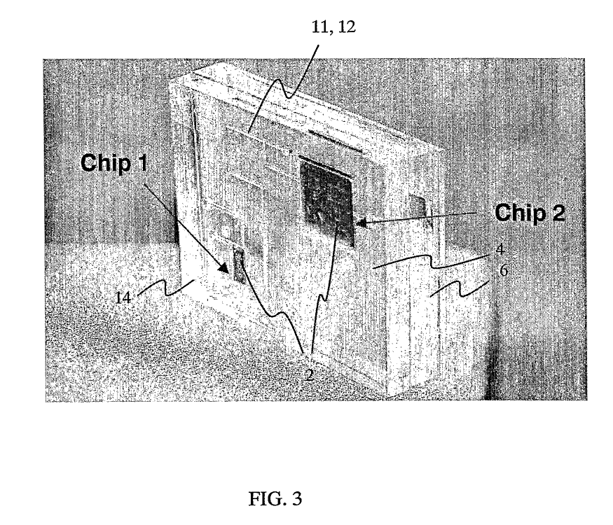

FIG. 3 shows a photograph of a fully assembled microfluidic package.

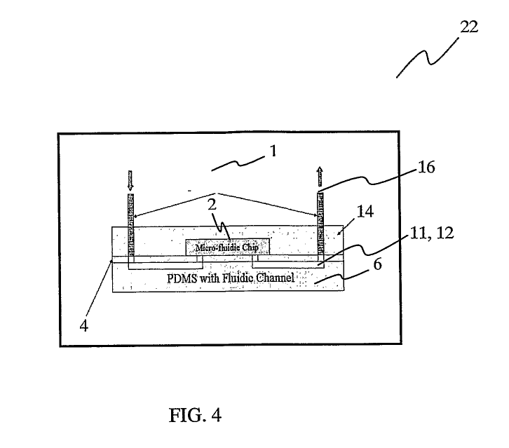

FIG. 4 is a schematic diagram of a simplified microfluidic package.

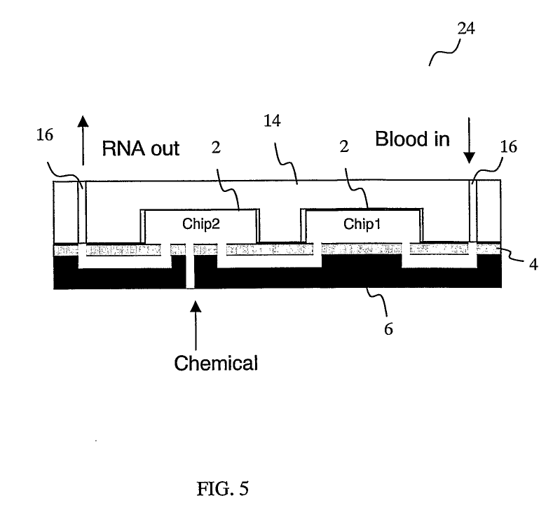

FIG. 5 is a schematic diagram of a microfluidic device in which blood a sample.

FIG. 6 shows a schematic diagram of a microfluidic device in which both fluidic chips are designed to receive externally introduced reagents via an inlet ports located in the substrate.

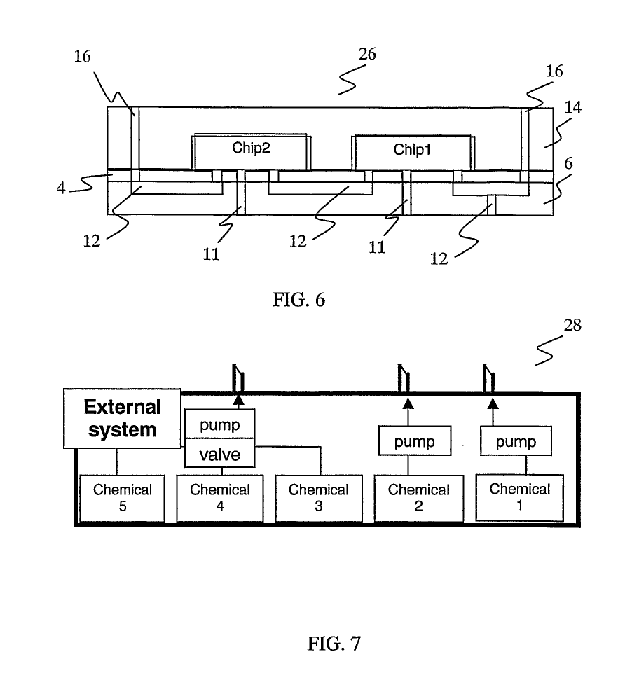

FIG. 7 shows a schematic diagram of an external delivery system for pumping chemicals into the microfluidic device.

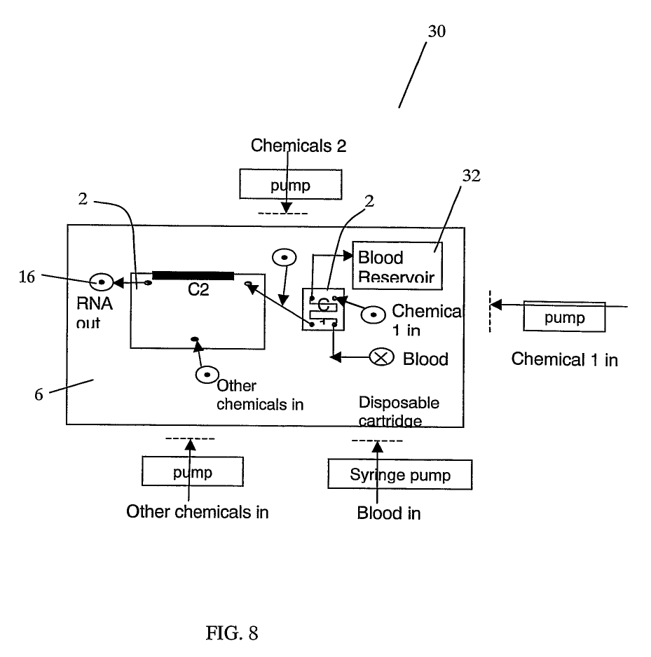

FIG. 8 shows a top view of a microfluidic device for sampling blood in which one of the fluid channels in the substrate is a blood reservoir.

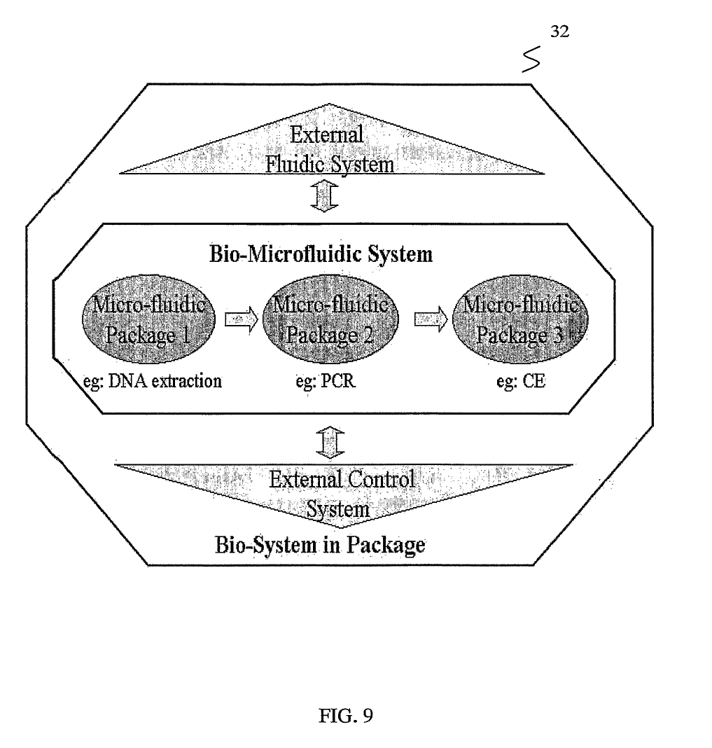

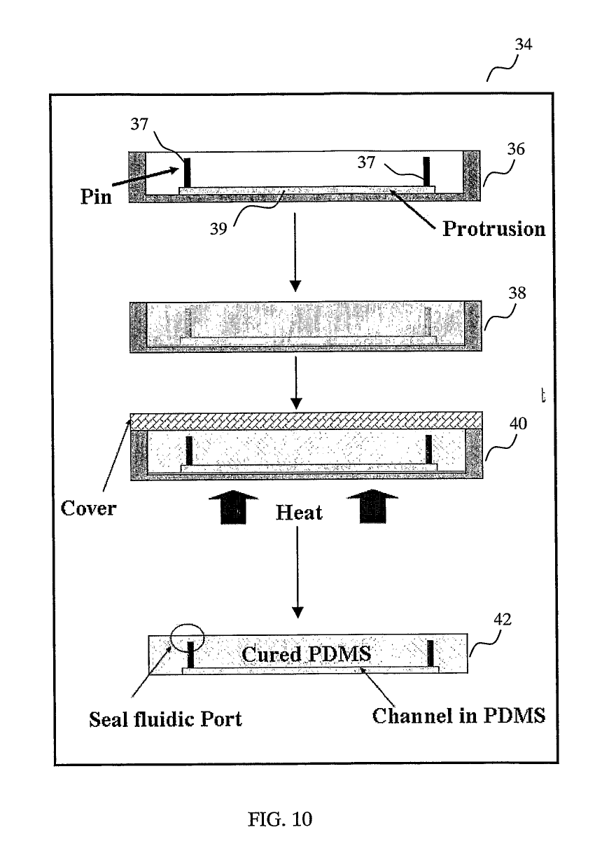

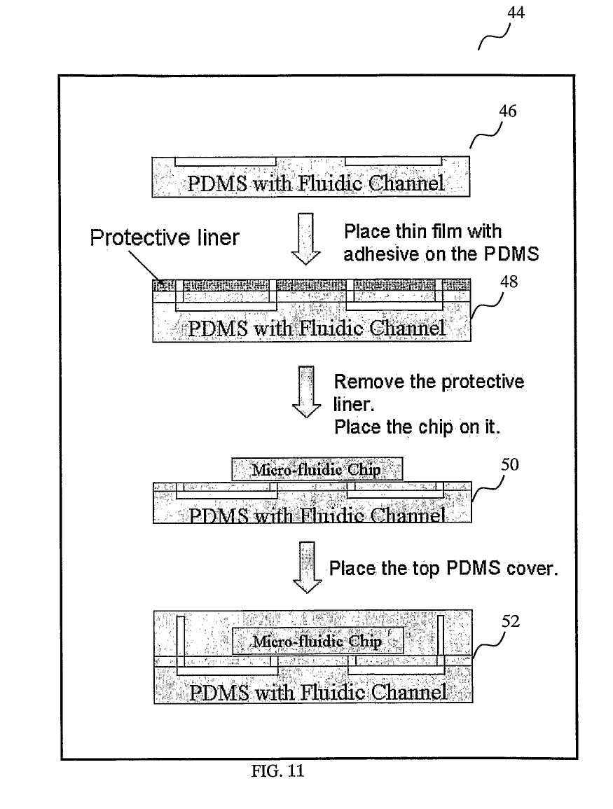

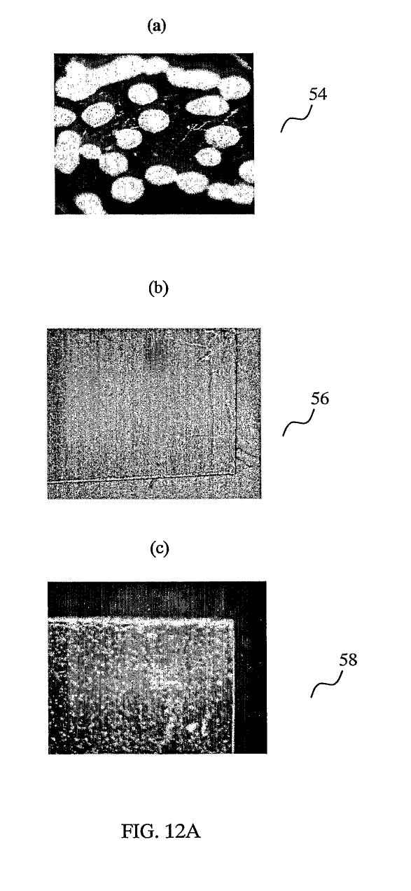

FIG. 9 shows a flow diagram illustrating the general relationship between a microfluidic package and external fluidic and flow control systems.

FIG. 10 shows a process of manufacturing a microfluidic package using soft lithography.

FIG. 11 shows the process flow of assembling a microfluidic package.

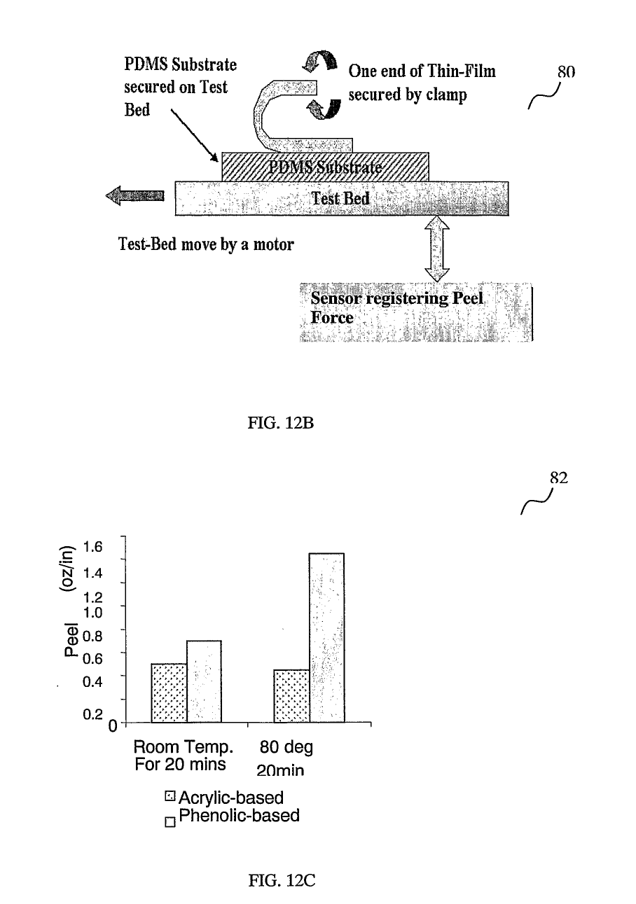

FIG. 12A shows photographs, enlarged via microscopy, of the surface of various tapes after having been exposed to ethanol in a chemical degradation test.

FIG. 12B shows the set up of a peel test, which was carried out on each of the various tapes. FIG. 12C shows a bar chart displaying the results of the peel test.

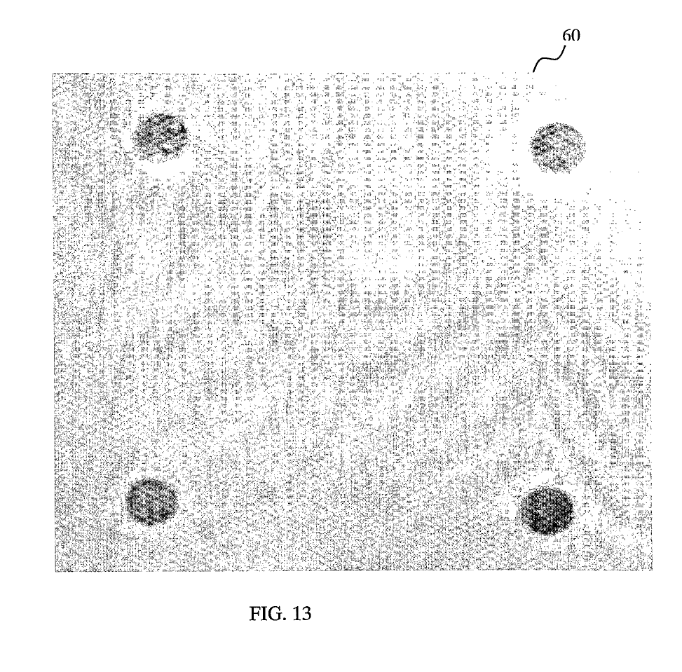

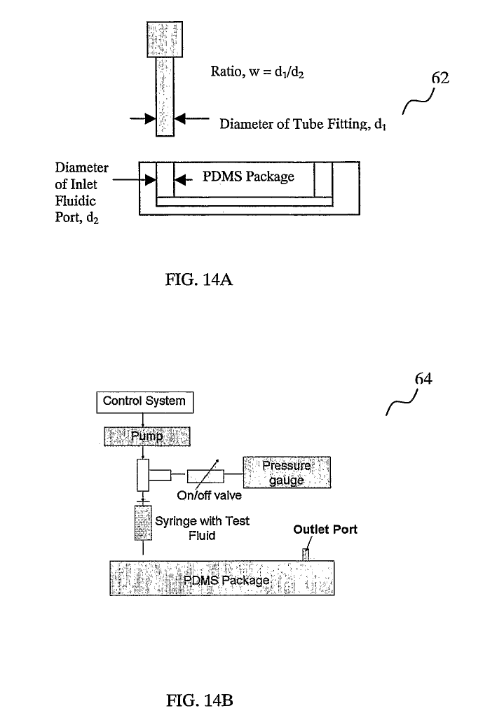

FIG. 13 is a photograph showing the sheet with four through-holes punched out.

FIG. 14A shows the relationship between the diameter of a tube fitting that is attached to the microfluidic package and the diameter of the inlet fluidic port of on the package receiving the tube fitting. FIG. 14B is a schematic diagram of an experimental setup for evaluating the fluid flow rate of a microfluidic package.

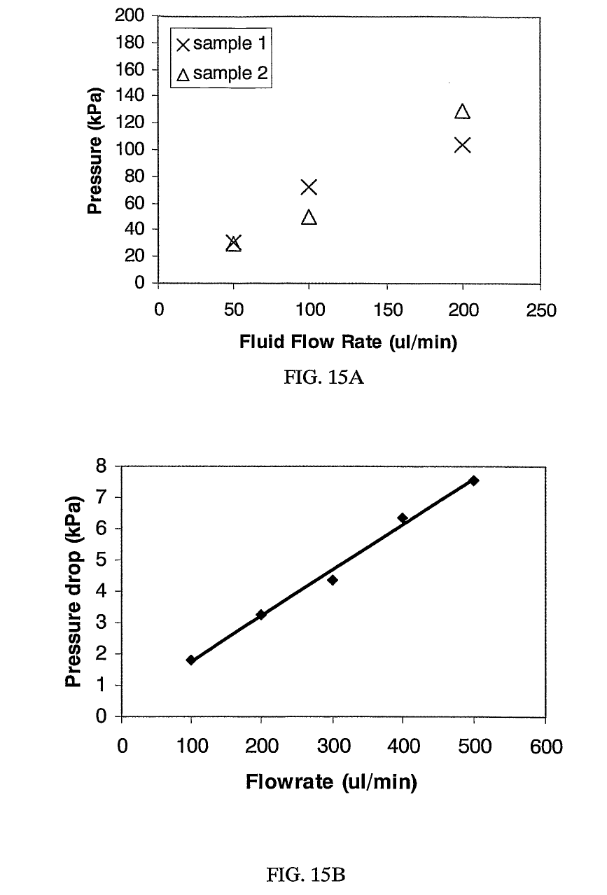

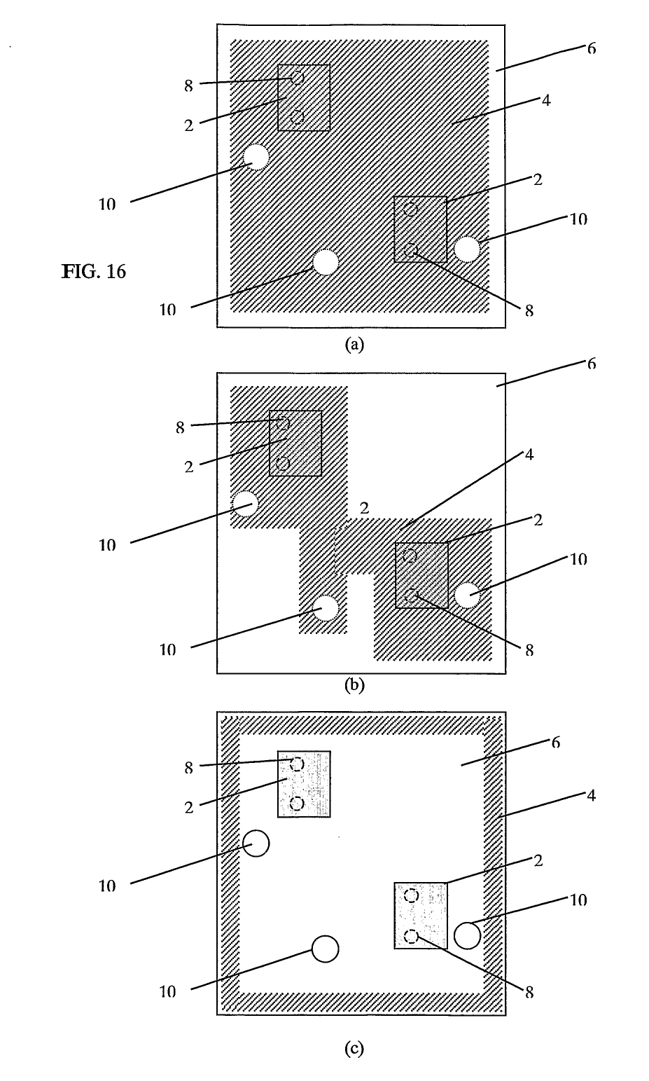

FIG. 15A is a graph showing the variation of pressure within the microfluidic package against fluid flow rate. FIG. 15B is a graph showing the variation of pressure drop across the microfluidic package with a smaller fluidic chip against flow rate in the experimental setup of FIG. 14B.

FIG. 16 shows various embodiments of the possible shapes and positions that the double-sided adhesive sheet used in the invention may assume.

FIG. 1 is an exploded isometric view of the microfluidics package 1. A substrate 6 with inter-connecting fluid channels 12 and singular fluid channels 11 are shown on the top surface of the substrate 6. A continuous sheet 4, adhesive on both sides, comprising of through-holes of two sizes, a smaller through-hole 8 and a larger through-hole 10. The sheet 4 is such that it covers the entire top surface of the substrate 6. Both sizes of through-holes 8,10 are positioned to meet at least one fluid channel 11,12 when the first adhesive side of the sheet 4 is secured to the top surface of the substrate 6. When attached to the substrate 6, the sheet 4 effectively seals off all fluid channels 11,12 with the exception of the exposed through-holes 8,10. Two fluidics chips 2 are then secured to the second adhesive side of the sheet 4. Each fluidic chip 2 is positioned over at least one through-hole 8,10. When the fluidic chip 2 is secured to the sheet 4 the fluid passages within the fluidic chip 2 are in fluid communication with the fluid flow channels 11,12 of the substrate 6 via the through-holes 8,10.

FIG. 2 is an exploded isometric view of the embodiment of the microfluidics device 1 with a cover 14. The cover 14 is placed over the fluidic chips 2 in order to better secure the fluidic chips 2 and to seal of the region of the fluidic chips 2, from the surrounding environment. The cover 14 will contact the remaining exposed surface portions of the sheet 4 to form the said seal. Recesses 20 are found on the underside of the cover 14 so as to accommodate the fluidics chips 2 when the cover is placed over the fluidics chips 2. The cover further comprises of inlet ports 16 that enable a user to pump test fluids or any additional reagents to be used as required. The inlet ports 16 are positioned directly over the preformed channels of the through-holes 10, and the fluid channels 11,12. In another embodiment, additional sheets 4 may be placed on the top surfaces of the fluidics chips 2 in order to increase the total surface area contact between the sheet 4 and the cover 14 thereby securing said cover 14 better.

FIG. 3 shows a photograph of a fully assembled microfluidic package. The substrate 6, the sheet 4, the two microfluidics chips 2 and the fluid flow channels 11,12 can be seen clearly.

FIG. 4 is a schematic diagram 22 of a simplified microfluidic package 1 incorporating a double-sided adhesive sheet 4 sandwiched between a substrate 6 and a top cover 14. The microfluidic chip 2 is accessible by two fluid channels 11,12 in the substrate 6. A tubing is inserted via inlet port 16 into the top cover 14 in order to access fluidic channels 11,12 in the substrate 6.

FIG. 5 is a schematic diagram 24 of a microfluidic device 1 in accordance with an embodiment of the invention. A simplified flow system is shown in which blood is injected into the inlet port 16 and diverted into a first fluidic chip 2, and subsequently to a second fluidic chip 2 via inter-connecting fluid channels 12. In addition, the second chip 2 receives a chemical, which is injected from an external source via a singular fluid channel 11. Subsequently, RNA is channeled to the outlet port 16 where it leaves the microfluidic package 1.

FIG. 6 shows a schematic diagram 26 of a microfluidic device 1 in accordance with a further embodiment of the invention in which both fluidics chips 2 are designed to receive externally introduced reagents via singular fluid channels 11 located in the substrate 6. As in the previous embodiment of FIG. 5, the sample is pumped in via an inlet port 16 in the cover 14 and into the first fluidic chip 2 via inter-connecting fluid channels 12 and on to the second fluidic chip 2 via a second set of inter-connecting fluid channels 12. Finally, the product exists the microfluidics package 1 via an outlet port 16 also located in the top cover 14.

FIG. 7 shows a schematic diagram of an external delivery system 28 for pumping chemicals into the microfluidic device illustrated in FIG. 5 and FIG. 6. The delivery system allows up to five chemicals to be pumped in however, more chemicals may be utilized with more complex pumping systems.

FIG. 8 shows a top view 30 of a further embodiment of the microfluidic device 1 for sampling blood. The blood sample is injected via inlet port 16 and is routed to a first fluidic chip 2. Upon entering the first fluidic chip 2, a first chemical is pumped directly into the chip via a singular fluid channel 11. The blood sample reacts with the first chemical and is later stored in a blood reservoir 32 for storing processed blood. Part of the blood sample proceeds on to a second fluidics chip 2. Along the way, the sample interacts with a second chemical that is pumped directly into the inter-connecting fluid channels 12. The sample enters the second fluidic chip 2 and subsequently, the processed RNA exits from the chip 2 via an outlet port 16.

FIG. 9 shows a flow diagram 32 illustrating the role of a microfluidic package within a Bio System in Package (Bio-SiP) and the relation thereof with external fluidic and flow control systems. The diagram illustrates that the microfluidics packages are used in series thereby conducting a variety of tests on a single sample. Such a system would be advantageous in that less fluidic samples would be used along with reduced skill dependence with regard to the user.

FIG. 10 shows a process 34 of manufacturing a microfluidic package using soft lithography. The process begins with the preparation of a master mold 36. The master mold comprises a pair of pins 37 and a protrusion 39. A second step 38 involves filling the master mold with liquid PDMS. During a third step 40, the entire master mold is covered and heated to thermally cure the PDMS. In a fourth step 42, the cured PDMS is removed from the master mold. The fluidic ports and channels will be sealed after the complete assembly of the package as shown in FIG. 11 to prevent any possible contamination prior to usage.

### EXAMPLE 1

### Chemical Soaking Test of 3 Adhesive-Based Thinfilm Material

The adhesion strength and bio-compatible with chemical reagents used in bio-analysis were the main selection criteria for the adhesive material. Three types of medical-grade adhesive were evaluated. These adhesives were supplied by Adhesives Research Pte Ltd (SG). The tape carrier is polyethylene (PET)-based and the adhesives used are, namely, silicone-based {Part number 02-50-01}, acrylic-based {Part number 02-76-01A} or phenolic-based {Part number 02-82-01}. The performance of the thin-film on bio-compatible and adhesion strength was evaluated by means of chemical soaking test and peel test respectively.

Bio-analysis such as Deoxyribonucleic Acids extraction or Viral Nucleic Acids extraction required chemical reagents. They were ethanol, lysis, Phosphate Buffered Saline (PBS) and solution with high salt concentration. The three selected adhesive thin-film were soaked in these chemical reagents for 10 minutes. The adhesive thin-film was observed under microscope for any visual defect after the chemical reagent soaking.

FIG. 12A shows photographs, enlarged via microscopy, of the surface of various tapes after having been exposed to ethanol in a chemical degradation test. Photograph (a) shows the surface of a silicone-based tape, photograph (b) shows the surface of an acrylic based tape, and photograph (c) shows the surface of a phenolic-based tape after the ethanol test. The silicone-based tape shows physical change as evidenced by the formation of permanent white spots on the tape after 10 min soaking in ethanol. Acrylic-based and Phenolic-based adhesive thin-film showed good bio-compatible to the chemical reagents used in bio-analysis. [see Table 1]. A peel test is also conducted on these two adhesive thin-film to identify the best adhesive to be used in the PDMS package.

TABLE 1
Chemical Test Results of the adhesive thin-film

| | Silicone-base | Acrylic-base | Phenolic-base |
|---|---|---|---|
| Before | Transparent | Transparent | Transparent |
| Soaking | | | |
| Ethanol | White spots | Transparent | Transparent |
| | on the tape | | |
| Lysis | Transparent | Transparent | Transparent |
| PBS | Transparent | Transparent | Transparent |
| High salt | Transparent | Transparent | Transparent |

### EXAMPLE 2

### Peel Test on 3 Adhesive-Based Thinfilm Material

The adhesion strength between the adhesive thin-film and PDMS substrate will affect the quality of the package in terms of maximum fluid pressure package before fluidic leakage or even cross-contamination between channels. Peel test was used to quantify the adhesion strength between adhesive thin-film and the PDMS substrate.

PDMS was cast into a rectangle substrate of size 50 mm×75 mm×1.5 mm thick. The Acrylic-based and Phenolic-based thin-film were placed on top of the PDMS substrate. During the Peel Test, the PDMS substrate was secured on the test-bed and one end of the adhesive thin-film was held by a clamp [FIG. 12B]. A motor moved the test bed with the PDMS substrate. The Peel Tester would register the peel force required to separate the adhesive thin-film from the substrate.

The prepared specimens were subjected to heat treatment for 20 min at room temperature and at 80° C. separately before the peel test. The test results were shown in FIG. 12C. Acrylic-based thin-film exhibited lower peel force than Phenolic-based adhesive thin-film. Phenolic-based thin-film was found to improve better than Acrylic-based thin-film after exposure to 80° C. for 10 min.

### EXAMPLE 3

### Evaluation of the Relationship Between Pressure Drop and the Ratio of Tube Fitting Diameter to Inlet Diameter

Fluidic Testing was conducted on the assembled PDMS package to understand the pressure drop of the package with regard to the ratio of the diameter of the tube fitting and the diameter of the inlet port, and the maximum fluidic pressure that the package can withstand without leakage [FIG. 14A]. Two types of fluid were used in the fluidic testing. Water was used in the test to check the PDMS package's fluidic performance and chemical reagents were used to verify whether the package's fluidic performance degrade under chemical reagents' influence.

The maximum pressure drop across the PDMS package was an indication of the quality of the macro-micro fluidic interconnects. The disposable PDMS package used a plug and play concept for its macro-micro fluidic interconnects. The quality of the macro-micro fluidic interconnects depended on the pressure acting on the tube fitting by the PDMS material. The pressure acting by the PDMS material depended on the ratio of the diameter of the tube fitting and the inlet port diameter.

The test was conducted to understand the maximum pressure drop of the package with respect to the ratio. The fluidic test setup was shown in FIG. 14B. The setup includes an external delivery system for injecting fluids into the package and comprises a 3-way connector for coupling a syringe injector, a pressure gauge, and a computer controlled pump. A syringe pump with variable flow-rate was used to inject fluid into the disposable PDMS package. Inlet Pressure was measured by a digital pressure gauge. The measured inlet pressure was the pressure drop across the package as the outlet port was open to ambient.

Three different tube fittings were used in this test. The test fluid was water. The results indicated the allowable pressure drop across the package increased as the ratio increases [Table 2]. This relationship helped in the selection process of the correct tube fitting with respect to the pressure drop across the package.

TABLE 2
PDMS Package's Pressure Drop with regard to ratio
of the tube fitting's diameter and the inlet port diameter

| | Ratio, | Pressure drop |
|---|---|---|
| No | d₁/d₂ | (kPa) |
| 1 | 1 | 100 |
| 2 | 1.3 | 280 |
| 3 | 1.7 | >320 |

### EXAMPLE 4

### Fluidic Test with Water and Chemical Reagents

Water was the working fluid in the first fluidic test and was introduced at a fixed flow rate. In the present example, the disposable PDMS package was subjected to three different flow-rates. Results indicated that the pressure drop across the package increased as flow rate increased [FIGS. 15A, 15B]. A flow rate of 500 μl/min could be achieved for a pressure drop of 7.5 kPa with a smaller fluidic chip in the package. The highest pressure was 100 kpa for 200 μl/min as obtained for a bigger fluidic chip in the microfluidic package. No leakage occurred at fluidic inlet port. The PDMS package remained intact after the water fluidic test. FIG. 15A is a graph showing the variation of pressure within the microfluidic package against fluid flow rate. The results of the measurement were obtained from 2 microfluidic packages with a bigger fluidic chip.

In a subsequent test, chemical reagents used in bio-analysis were used to investigate the biocompatibility of PDMS package. The chemical reagents were Phosphate Buffered Saline (PBS), lysis buffer, high salt and ethanol. With 10 μl/min flow rate, chemicals flowed smoothly through the package. The duration of the test was 10 min. No fluidic leakage and blockage were detected on PDMS package.

The disposable PDMS package was then subjected to a biomedical application for extraction of viral nucleic acids (RNA) from blood sample. The blood was spiked with plant virus particles and pumped along with other chemical reagents through the package containing the chip. The elute solution collected from the package was analyzed by the conventional laboratory techniques and the viral RNA was successfully amplified and detected within the elute solution. This result indicated that the adhesive thin-film used and the PDMS package did not inhibit the subsequent stages of nucleic acid amplification and detection. It was also observed that the chemical reagents used for the extraction process did not react with the adhesive and the PDMS material. Thus, the package remained intact with fluidic channels clear, providing a leak-proof interface to the chip throughout the bio analysis process.

FIG. 16 shows various possible embodiments that the double-sided adhesive sheet used in the invention may assume. Reference numbers used therein are in accordance with those used for all the aforementioned figures. These shapes include continuous and regular shapes such as a rectangle (which also extends over the entire top surface of the substrate) (see FIG. 16(a)). Continuous and irregularly shaped sheets may also be used and its shape can be designed according to the position of the fluidic chips/fluidic channels in the substrate (b), or a border-like shape located along the periphery of the substrate as shown in (c). Discontinuous and regular shapes can take the form of several identical or different small pieces of sheets placed at appropriate positions on the substrate (d). Discontinuous and irregularly shaped sheets may comprise several identical or different small pieces of irregularly shaped sheets placed at appropriate positions on the substrate (e) to overlap with the fluid channels and/or fluidic ports. FIG. 16(f) is an illustration of an embodiment wherein the adhesive sheet assumes a circular shape, elliptical or annular (donut-shaped) shape. FIG. 16(f) is a further exemplary embodiment of an adhesive discontinuous sheet wherein only selected portions of the top surface of the substrate are covered (and sealed) by the said sheet. The selected portions include the fluidic channels on the top surface of the substrate. The adhesive sheet, as shown, also covers selected portions of the bottom surface of the microfluidics chip, said selected portions of the bottom surface of the microfluidics chip include the interface between the fluid passages of the microfluidics chip and the fluid channels of the top surface of the substrate.

1. A microfluidic package comprising:
a substrate having at least one surface comprising at least one fluid channel,
at least one fluidic chip having a top surface, a bottom surface, at least one side surface, and at least one passage configured to allow a fluid to traverse from the top surface or any of the at least one side surface to the bottom surface of the chip; and
a sheet of which both sides are adhesive, wherein the first adhesive side of the sheet is attached to the at least one surface of the substrate, and wherein the at least one fluidic chip is secured by the second adhesive side of the sheet, such that the at least one passage of the fluidic chip is in fluid communication with the at least one fluid channel of the substrate.

2. The microfluidic package of claim 1, wherein the sheet is continuous and regularly shaped.

3. The microfluidic package of claim 1, wherein the sheet is continuous and irregularly shaped.

4. The microfluidic package of claim 1, wherein the sheet is formed from a plurality of individual sheets.

5. The microfluidic package of claim 4, wherein the plurality of sheets comprises a plurality of smaller sheets at least one of which is discontinuous and regularly shaped so as to at least partially cover the top surface of the substrate.

6. The microfluidic package of claim 4, wherein the plurality of sheets comprises a plurality of smaller sheets at least one of which is discontinuous and irregularly shaped so as to at least partially cover the top surface of the substrate.

7. The microfluidic package of claim 1, wherein the sheet covers only the at least one fluid channel of the at least one surface of the substrate.

8. The microfluidic package of claim 1, wherein the sheet covers non-fluid channel portions of one or more of the at least one surface of the substrate.

9. The microfluidic package according to claim 8, wherein the sheet covers a periphery of the top surface of the substrate.

10. The microfluidic package of claim 1, wherein the sheet seals the at least one fluid channel of the at least one surface of the substrate from the at least one fluid flow passage of the fluidic chip.

11. The microfluidic package of claim 1, further comprising a membrane that is attached to the sheet.

12. The microfluidic package of to claim 11, wherein the membrane is aligned with the at least one fluid channel of the at least one surface of the substrate such that the membrane seals the at least one fluid channel of the at least one surface of the substrate from the at least one fluid flow passage of the fluidic chip.

13. The microfluidic package of claim 1, wherein the sheet further comprises at least one through-hole configured to allow the at least one fluid channel of the at least one surface of the substrate to be in fluid communication with the at least one passage of the fluidic chip.

14. The microfluidic package of claim 13, wherein the at least one through-hole is connected to the at least one fluid channel of the substrate and to the at least one passage of the fluidic chip to allow a fluid to traverse from the top surface or any of the at least one side surface of the fluidic chip to the at least one fluid channel of the at least one surface of the substrate.

15. The microfluidic package of claim 1, wherein the fluidic chip further comprises at least one fluid inlet port and at least one fluid outlet port.

16. The microfluidic package of claim 15, wherein either of the at least one inlet port and the at least one outlet port are located on the top surface, any of the side surfaces or on the bottom surface of at least one fluidic chip.

17. The microfluidic package of claim 1, wherein the entire bottom surface of the at least one fluidic chip is attached to the sheet.

18. The microfluidic package of claim 1, wherein a part of the bottom surface of the at least one fluidic chip is attached to the sheet.

19. The microfluidic package of claim 1, wherein the fluidic chip is electronically connected to a printed circuit board.

20. The microfluidic package of claim 1, wherein the substrate comprises at least one inlet port and at least one outlet port each configured to permit fluid flow.

21. The microfluidic package of claim 1, wherein the at least one surface of the substrate is a top surface, and wherein the at least one surface of the substrate comprises a top surface of the substrate, where the top surface of the substrate further comprises a plurality of inter-connected fluid channels.

22. The microfluidic package of claim 1, wherein the at least one fluid channel comprises at least one sample storing reservoir.

23. The microfluidic package of claim 1, wherein the substrate comprises a material selected from the group consisting of semiconductor materials and electrically insulating materials.

24. The microfluidic package of claim 1, wherein the substrate comprises a material selected from the group consisting of elemental silicon, polymeric silicones and glass.

25. The microfluidic package of claim 24, wherein the substrate comprises a polymeric silicone selected from the group consisting of polydimethylsiloxane, polydiethylsiloxane, polydipropylsiloxane and mixtures thereof.

26. The microfluidic package of claim 26, wherein the sheet comprises a multi-layer structure.

27. The microfluidic package of claim 26, wherein the multi-layer structure comprises a supporting layer with at least two adhesive sides.

28. The microfluidic package of claim 27, wherein the supporting layer comprises a material selected from the group consisting of elastic polymers, thermoplastic polymers and thermosetting polymers.

29. The microfluidic package of claim 28, wherein the thermoplastic polymer is selected from the group consisting of carbon chain polymers and heterochain polymers.

30. The microfluidic package of claim 29, wherein the carbon chain polymer is selected from the group consisting of polyvinyl acetates and polyvinyl alcohol.

31. The microfluidic package of claim 1, wherein the sheet comprises an adhesive obtained from a material selected from the group consisting of acrylates, cyanoacrylates, amino resins, phenolic resins, epoxies and silicones.

32. The microfluidic package of claim 1, further comprising a cover plate secured by means of a second sheet either to the top surface of the at least one fluidic chip or to the top surface of the substrate.

33. The microfluidic package of claim 32, wherein the second sheet is positioned between the cover plate and the top surface of the at least one fluidic chip.

34. The microfluidic package of claim 32, wherein the second sheet is positioned between the cover plate and the at least one surface of the substrate.

35. A method of assembling the microfluidic package of claim 1, the method comprising:
attaching a sheet comprising two adhesive sides onto a top patterned surface of the substrate or attaching said sheet to the bottom surface of the at least one fluidic chip; and
securing the at least one fluidic chip on top of the at least one surface of the substrate.

36. A method of assembling the microfluidic package of claim 32, further comprising:
securing a second sheet having two adhesive sides to the top surface of the at least one fluidic chip or on any exposed portion of the top surface of the substrate; and
securing a cover plate to the second sheet.

37. A method of fabricating the substrate of a microfluidic package, the substrate having a surface comprising at least one fluid channel, said method comprising:
providing a master mold comprising:
at least two pins for creating at least one sealed inlet passage and one sealed outlet passage, and
at least one protrusion for creating at least one fluid channel,
depositing a precursor of the substrate material into the master mold, and
allowing the precursor to solidify, thereby forming the substrate.

38. The method according to claim 37, wherein the substrate is formed by a method selected from a group consisting of casting, molding and lithography.

39. The method according to claim 38, wherein said method of casting is selected from investment casting, centrifugal casting, cold casting and potting.

40. The method according to claim 38, wherein said method of molding is selected from compression molding and injection molding.

41. The method according to claim 38, wherein said method of lithography is selected from soft lithography, ultraviolet lithography and imprint lithography.

42. The method according to claim 37, wherein the precursor is selected from the group consisting of polydimethylsiloxane, polydiethylsiloxane, polycarbonate, polyethylene, polyvinylchloride, polyamides, polyethyleneterephthalate (PET)), polycarbonate (PC), polyimide and polydipropylsiloxane.

43. A substrate obtainable from the method of claim 37, said substrate comprising:
a surface, said surface comprising at least one fluid channel,
at least one sealed inlet passage, and
at least one sealed outlet passage.

44. The microfluidic package of claim 2, wherein the sheet is dimensioned to the top surface of the substrate.

45. The microfluidic package of claim 3, wherein the sheet is dimensioned to the top surface of the substrate.
